(19) United States
(12) Patent Application Publication
(10) Pub. No.: US 2019/0075764 A1
(43) Pub. Date: Mar. 14, 2019

(54) TUNA AQUACULTURE POOL

(71) Applicants: Ali ALKRERNAWI, Sderot (IL); Yosef DE LEVIE, Tel Aviv (IL)

(72) Inventors: Ali ALKRERNAWI, Sderot (IL); Yosef DE LEVIE, Tel Aviv (IL)

(21) Appl. No.: 16/084,571

(22) PCT Filed: Mar. 13, 2017
(86) PCT No.: PCT/IL2017/050319

§ 371 Date: Sep. 13, 2018

Related U.S. Application Data
(60) Provisional application No. 62/307,506, filed on Mar. 13, 2016.

(51) Int. Cl. A01K 63/00; A01K 61/10

(52) U.S. Cl. CPC A01K 63/00; A01K 61/10

(57) ABSTRACT

An aquaculture pool, including: an edge of the pool running along a circumference of the pool; and walls tapering from said edge to a floor of the pool, wherein the pool is devoid of vertical walls.

### FIELD OF THE INVENTION

The present invention relates to a aquaculture pool and, more particularly, to an aquaculture pool designed to prevent or minimize collisions of the fish with the pool walls.

### BACKGROUND OF THE INVENTION

Bluefin tuna fish can grow to a weight of about 400 kilograms. They can swim up to about 80 kms per hour and cross entire oceans. They are also valuable. Demand for tuna has grown, especially in Japan, where people sometimes pay fantastic prices for the fish. That demand has led to overfishing, and wild populations of tuna now are declining. One of the direct results of population decline is bluefin tuna farming.

Bluefin tuna are regarded as particularly difficult to cultivate because of their sensitivity to conditions when laying eggs. Even if the eggs hatch there is only a 3 percent chance that a hatchling will become a six-centimeter-long fry. There is only a 0.1% chance the fish will reach a salable size (1 to 1.5 meters long) and be sold in markets. Even if they make it to adulthood, many die when the fish panic and ram into the net or side of the enclosure. About half of the bluefins die in collisions despite being kept in huge circular pens.

### SUMMARY OF THE INVENTION

The present invention discloses an innovative aquaculture pool that has a structure designed to prevent fish, and specifically tuna, from colliding with the walls of the pool, as such collisions generally result in the death of the fish and are accountable for about 50% of tuna fatalities in captivity. It is made clear that the aquaculture pool of the immediate invention is not restricted to tuna, rather the pool can be used for farming any type of fish or other aquatic creatures.

According to the present invention there is provided an aquaculture pool, including: an edge of the pool defining a circumference of the pool; and walls tapering from said edge to a floor of the pool, wherein the pool is devoid of vertical walls.

According to further features in preferred embodiments of the invention described below the pool is circular in shape.

According to still further features in the described preferred embodiments a water-facing surface of the pool defines an inverted conical shape.

According to further features the pool further includes a flat, horizontal floor.

According to further features water-facing surfaces of the pool are coated with waterproof material.

According to further features the waterproof material has a thickness between 0.125 and 0.25 inches.

According to further features the waterproof material has a thickness between 0.0625 and 0.5 inches.

According to further features the waterproof material has a thickness of more than 0.5 inches.

According to further features an angle of inclination of said walls is greater than two degrees and less than forty five degrees.

According to further features an angle of inclination of said walls is greater than forty five degrees and less than ninety degrees.

According to another embodiment there is provided an aquaculture pool, including: a rim defining a circumference of the pool; and a floor inclined from a base of the pool to said rim, wherein the pool is devoid of walls.

The present invention successfully addresses the shortcomings of the presently known configurations by providing an aquaculture pool that has a tapered floor and no vertical walls.

### BRIEF DESCRIPTION OF THE DRAWINGS

Various embodiments are herein described, by way of example only, with reference to the accompanying drawings, wherein:

FIG. 1 is a cross-sectional view of an aquaculture pool with tapered walls;

FIG. 2 is a cross-sectional view of an aquaculture pool with tapered floor;

FIG. 3 is a table of three commonly used notations (degrees, percent and ratio) together with formulas for slope determination as well as an example.

### DESCRIPTION OF THE PREFERRED EMBODIMENTS

The principles and operation of an aquaculture pool according to the present invention may be better understood with reference to the drawings and the accompanying description.

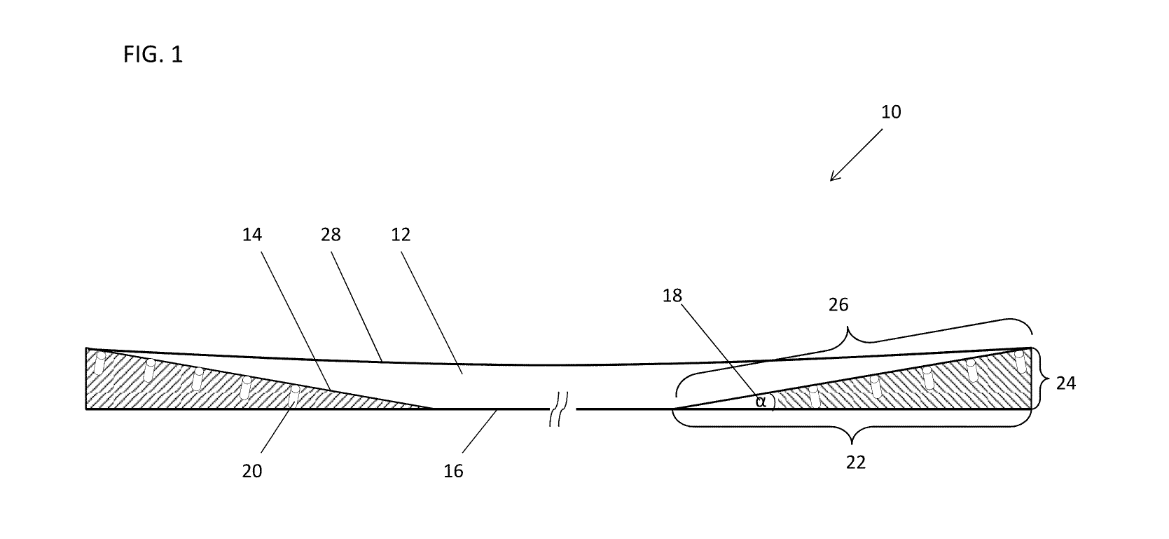

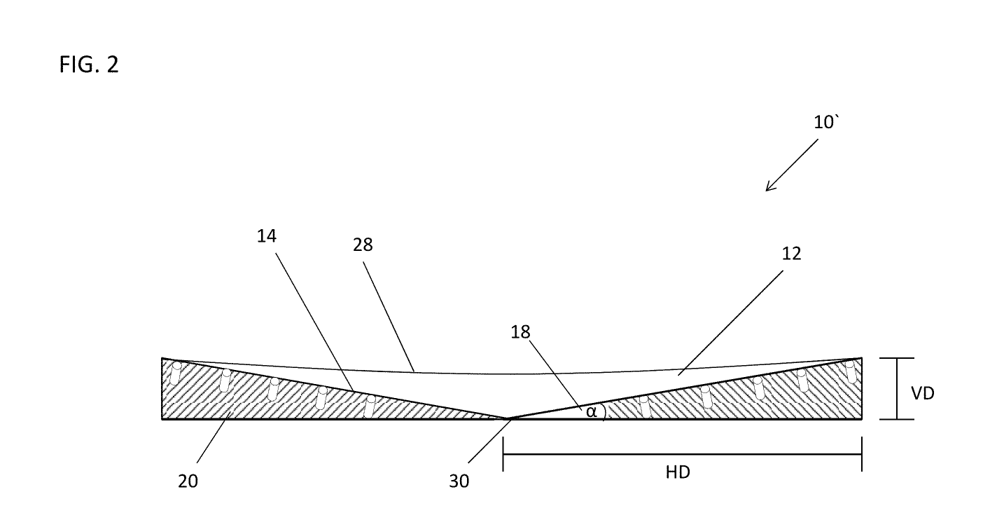

Referring now to the drawings, FIG. 1 illustrates a cross-sectional view of an aquaculture pool 10 with tapered walls 12. The aquaculture pool includes an edge 28 that runs the circumference of the pool. A circumferential rim 28 runs around or defines an edge of the pool. The circumference of the pool is the enclosing boundary of the curved geometric figure or shape of the pool. That is to say that the pool has a curved geometry such as a circular shape, an oval shape, an elliptical shape or any other curved geometric figure that forms a complete circuit. The walls 12 of the pool are tapered, moving away from the edge 28 both vertically and horizontally towards the center of the pool. A pool with a circular circumference has an inverse conical shape, such that the walls 12 can actually be seen as a single circular wall descending from the edge of the pool to the floor of the pool. In some embodiments the walls all meet on the floor of the pool (see FIG. 2). That is to say that the walls meet at the apex of the (inverse conical shaped) pool.

In other embodiments, such as shown in FIG. 1, the wall or walls reach the floor of the pool but do not meet. Rather, the pool includes a horizontal floor 16. The pool may alternatively be an oval shape, an elliptical shape or any other circumferential shape (defining a bounded geometric figure). In an alternative manner of viewing the pool, it can be said that the pool includes a rim 28 and a sloped floor 26, with no walls at all. While both definitions are applicable to the same structure, it can be said that the definition of a circumferential pool with a sloped floor which is devoid of vertical walls (or any walls for that matter) is particularly applicable to the embodiment of the pool where the walls meet at the apex of the pool (e.g. FIG. 2).

The pool is designed in such a way that there are no vertical walls for the tuna fish to collide with. The diameter of the pool is dictated by the desired volume of the pool. Since the slanted walls reduces the overall volume of the pool (also the area near the lip would not be suitable for fish to swim in as it is too shallow), the way to increase the volume of the pool by increasing the diameter of the pool.

Furthermore, the walls are conical in shape and have such a gentle incline angle α 18 that the fish have no vertical wall or wall with a sufficiently steep angle with which to collide. Instead, a fish swimming at the boundary wall will “glance” of the wall without causing damage to itself.

The slope or gradient of the walls or floor is a central feature of the innovative pool. In preferred embodiments angle of the sloping walls/floor is greater than two degrees (2°) and less than forty five degrees (45°). In other embodiments, the angle of the slope of the walls/floor is greater than 45°. In other embodiments, the angle of the slope of the walls/floor is greater than 67.5°. In all embodiments, the angle of the slope is less than 90°.

In some embodiments, the angle of the slope is not consistent from the bottom of the pool to the lip or edge of the pool. In a non-limiting example, the lower half or two-thirds of the wall/floor may be 22.5° while the upper half or upper third of the wall/floor may be at a 45° angle.

For the sake of clarity, all of the angles mentioned herein refer to the angle between the tapered wall/floor (slope) and the longitudinal axis defined by the flat (horizontal) floor. In a case such as depicted in FIG. 2, where there is no horizontal floor, the horizontal line is an imaginary longitudinal axis extending from the apex of the inverse conical-shaped pool towards an imaginary vertical axis descending from the lip of the pool, where the horizontal axis is parallel to the horizontal water line of the pool. In FIG. 2, the length of the horizontal axis is the referred to as HD and the length of the vertical line is referred to as VD.

Using an alternative definition, the grade (also called slope, incline, gradient, mainfall, pitch or rise) of a physical feature (here referring either to the floor or the walls 26) refers to the tangent of the angle 18 of that surface 26 to the horizontal 22. It is a special case of the slope, where zero indicates horizontality. A larger number indicates higher or steeper degree of “tilt”. Often slope is calculated as a ratio of “rise” 24 to “run” 22, or as a fraction (“rise over run”) in which run is the horizontal distance and rise is the vertical distance.

There are several ways to express slope. Herein slope is generally expressed as an angle of inclination to the horizontal. The angle α 18 is opposite the “rise” side of a triangle with a right angle between vertical rise 24 and horizontal run 22.

In some embodiments, the surfaces (wall 14 and floor 16) of the pool are coated with a material that provides one or more of the following features: a smooth coating to prevent scratches or other damage to the fish and to facilitate the smooth gliding as the fish rub lightly against the side walls or glance off the sides; a padding which easily deforms to absorb some of the kinetic energy of the fish that glancingly hit the walls, so as to minimize damage to the fish; a non-porous coating that prevents the adhesion of micro organisms to the walls.

Coatings commonly used in farming ponds and garden ponds include Bentonite, liquid rubber, vinyl, polyurea pond liner, spray liners and many more. The property of swelling on contact with water makes sodium bentonite useful as a sealant, since it provides a self-sealing, low-permeability barrier. Bentonite is used to line the base of landfills to prevent migration of leachate, for quarantining metal pollutants of groundwater, and for the sealing of subsurface disposal systems for spent nuclear fuel. Similar uses include making slurry walls, waterproofing of below-grade walls, and forming other impermeable barriers, e.g., to seal off the annulus of a water well, to plug old wells.

Bentonite can also be “sandwiched” between synthetic materials to create geosynthetic clay liners (GCLs) for the aforementioned purposes. This technique allows for more convenient transport and installation, and it greatly reduces the volume of bentonite required. It is also used to form a barrier around newly planted trees to constrain root growth so as to prevent damage to nearby pipes, footpaths and other infrastructure. Farmers use bentonite to seal retention ponds.

Paint-on and spray-on liners also offer a waterproofing solution. In some cases, the liner can be thickly applied. For example, a coat which is between one eighth and quarter-inch thick gives a flexible texture. Thickening the coating can prevent damage to the fish that glance off the walls and/or floor. Some liners simply come in sheets which are laid down and attached or adhered to the surface. It is made clear that while some surfaces and coatings are more preferable than others, the present innovation applies equally to surfaces and coatings of pools.

In some embodiments, the walls 12 of the pool 10 have a plurality of water jets 20 that repulse the fish away from the surfaces. In some embodiments, the floor also includes water jets (not shown).

In some embodiments, the water jets 20 are angled in such a manner that the jet stream of water creates a current (e.g. in a clock-wise direction) in the pool. The current further ensures that the fish do not collide with the walls.

As many of the features are similar to the first embodiment shown in FIG. 1, the description for the first embodiment is hereby incorporated by reference for the second embodiment. Where like or similar features or elements are shown, the same reference numbers will be used where possible. The following description for the second embodiment will be limited primarily to the differences between the first and second embodiments.

FIG. 2 is a cross-sectional view of a second embodiment of the aquaculture pool. Unlike the first embodiment shown in FIG. 1, aquaculture pool 10′ has no flat (horizontal or vertical) surfaces. The floor 12 of pool 10′ has a gentle slope rising from a center or apex 30 of the pool 10′ which is the deepest area. The center of the pool is the apex of the inverse conical shape of the pool. The size and depth of the pool can be calculated by the gradient of the slope or vice versa. The height of the pool is referred to herein as the vertical distance VD and the radius of the pool is referred to herein as the horizontal distance HD.

The recommended dimensions of an aquaculture tuna pool are at least ten (10) meters depth (VD=10 m) and thirty (30) meters diameter (the radius is HD=15 m). For the sake of providing an example, we show the relationship between the depth, diameter and slope gradient. It is however understood that a pool with the aforementioned dimensions is not ideal or recommended, as the recommendation of ten meter depth and thirty meter diameter refers to an enclosure with vertical walls, not a tapered floor as disclosed herein.

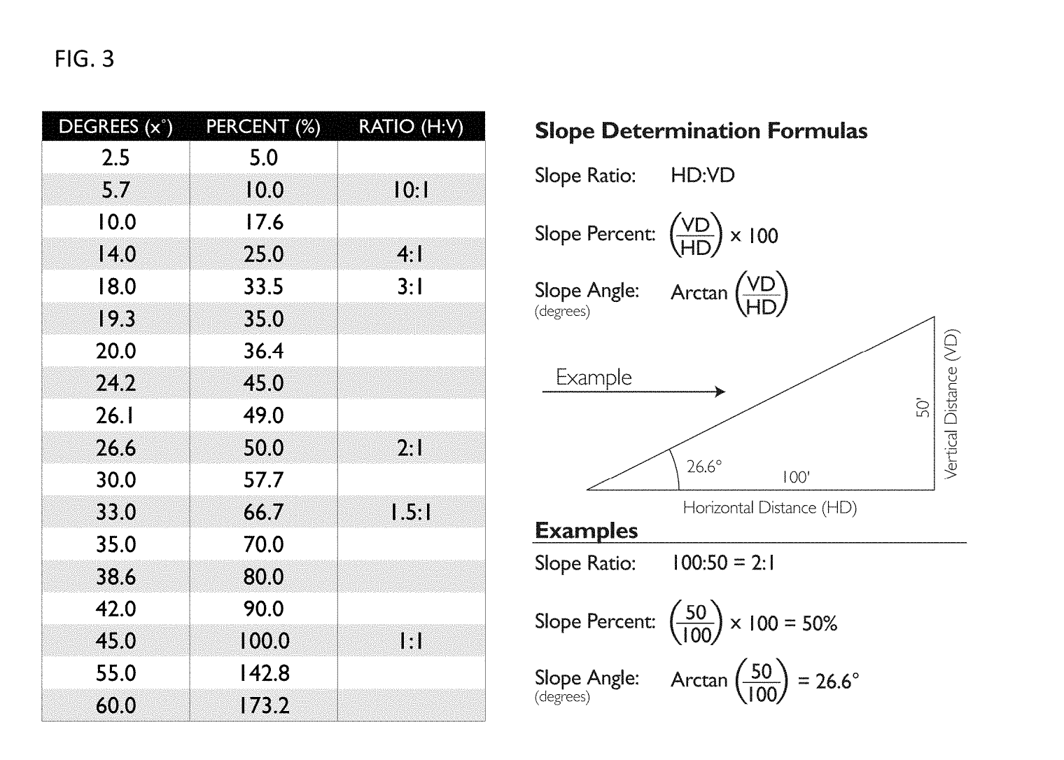

FIG. 3 includes a table of three commonly used notations (degrees, percent and ratio) together with formulas for slope determination as well as an example. Referring only to the table, the run (horizontal distance) to rise (vertical distance) ratio for a fifteen meter radius (thirty meter diameter) of the pool and ten meter depth of the pool is 1.5:1. The angle of the slope will therefore be approximately 33° (degrees).

The dimensions of the pool can be adjusted according to preference and/or based on the latest research. For example, changing one of the variables, such as depth, will result in a change of gradient, if the diameter remains the same. In the case of a pool whereby the slope gradient of the walls is a given degree and the depth of the pool is a given vertical distance (VD) but the radius (HD) of the pool needs to be larger, then a configuration such as that presented in FIG. 1 is more applicable.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. An aquaculture pool, comprising:
an edge of the pool running around a circumference of the pool; and
walls tapering from said edge to a floor of the pool, wherein the pool is devoid of vertical walls.

2. The pool of claim 1, wherein the pool is circular in shape.

3. The pool of claim 2, wherein a water-facing surface of the pool defines an inverted conical shape.

4. The pool of claim 1, further comprising a flat, horizontal floor.

5. The pool of claim 1, wherein water-facing surfaces of the pool are coated with waterproof material.

6. The pool of claim 5, wherein said waterproof material has a thickness between 0.125 and 0.25 inches.

7. The pool of claim 5, wherein said waterproof material has a thickness between 0.0625 and 0.5 inches.

8. The pool of claim 5, wherein said waterproof material has a thickness of more than 0.5 inches.

9. The pool of claim 1, wherein an angle of inclination of said walls is greater than two degrees and less than forty five degrees.

10. The pool of claim 1, wherein an angle of inclination of said walls is greater than forty five degrees and less than ninety degrees.

11. An aquaculture pool, comprising:
a rim around a circumference of the pool; and
a floor inclined from a base of the pool to said rim, wherein the pool is devoid of walls.
